(19) United States
(12) Patent Application Publication
(10) Pub. No.: US 2009/0251886 A1
(43) Pub. Date: Oct. 8, 2009

(54) LIGHT-EMITTING DISPLAY DEVICE APPLING CRYSTAL

(76) Inventor: Jae-Hak Ryu, Gyeonggi-Do (KR)

Correspondence Address: IPLA P.A., 3580 WILSHIRE BLVD., 17TH FLOOR, LOS ANGELES, CA, 90010, US

(21) Appl. No.: 12/373,236

(22) PCT Filed: Jun. 27, 2007
(86) PCT No.: PCT/KR07/03112

§ 371 Date: Jan. 9, 2009

(30) Foreign Application Priority Data
Jul. 14, 2006 (KR) 10-2006-0066430

(51) Int. Cl. G09F 13/04

(52) U.S. Cl. 362/97.1

(57) ABSTRACT

A light emitting display device equipped with a transparent crystal is disclosed which comprises an outer casing which is embedded under the ground and forms an outer structure; a transparent crystal member which is inserted into the interior of the outer casing and reflects light using a reflection mirror effect of an inner vertical wall surface of the same; a solar cell module which is impregnated into a space formed at a center lower surface of the transparent crystal member with the help of a molding liquid and concentrates a sunshine and converts a light energy into an electrical energy and changes the same; and a light emitting unit which is engaged at a lower surface of a surrounding portion of the transparent crystal member and emits light to the outside based on a power supply by means of the sunshine or the solar cell module.

### TECHNICAL FIELD

The present invention relates to a light emitting display device equipped with a transparent crystal, and in particular to a light emitting display device equipped with a transparent crystal in which a solar cell module is provided in the interior of a transparent crystal, and an electric energy is charged by concentrating light during a daytime irrespective of an inclination of light emitted into a solar cell, and a light emitting device emits a light via a light spreading embossing guide plate based on the charged electric energy, so that it is possible to more clearly display a certain information such as a character or image etched on a transparent crystal.

### BACKGROUND ART

A conventional display device is widely used using a light source for displaying various characters or patterns based on an optical fiber. The above display device needs a power supply source for supplying power to a light source. When it is needed to installed at a road, a building, a park or a local facility out of the downtown of a city in which it is impossible to supply power, a display device which can use a solar cell module as a power supply source is developed and used.

FIG. 1 is a cross sectional view illustrating a road display device using a solar cell in the conventional art. There is shown a display device which uses a solar cell module.

As shown therein, the road display device using a solar cell module comprises a light collecting plate 40 disposed between an upper housing 20 and a lower housing 30 provided at an upper side of a base 10, and a light emitting unit which includes a battery (not shown), a printed circuit board (not shown) and a light emitting diode 50. Since it is installed at a center of the road or a marginal side of the same and is designed to automatically reflect light from a vehicle headlight or to automatically emit light, so that a user can recognize a lane when driving in the night or in a bad weather condition and can recognize a curved degree of a road.

The conventional display device using a solar cell converts a light energy of sun into an electrical energy using a solar cell module in a daytime and charges the converted electrical energy into a battery such as a lithium ion secondary battery and supplies the charged electrical energy to a light emitting diode in the night for thereby displaying a display information.

The solar cell is a semiconductor device which is formed of a P, N-junction layer and generates a current using a free movement of free electrons at a P-layer and N-layer based on a solar light (photon).

When the solar cell module which is a power supply source of the display device is exposed to a sunshine for a long time, the temperature of the module increases, and the voltage of the solar cell decreases. So, the current is relatively increased depending on the increase of the temperature. As the increasing amount of the current exceeds the increasing amount of the voltage, the efficiency of the solar cell module relatively increases.

However, when a certain shadow is formed at a certain portion of the solar cell module, the shadow portion may disturb the generation of the current since it becomes a nonconductive portion (resistance), the output of the solace cell plate significantly decreases, and the entire efficiency of the module also significantly decreases.

The conventional display device is made of a polycarbonate material semi-transparent in its surface, the light from the interior of the display device is partially blocked by means of a semitransparent material, so that a visual effect may decrease. Since the light from the display device is nearly reflected in a vertical direction, it is impossible to recognize the contents displayed by the display device in all directions, so that an inherent function is not performed.

### DISCLOSURE OF INVENTION

### Technical Problem

Accordingly, it is an object of the present invention to overcome the problems encountered in the conventional art.

It is another object of the present invention to provide a display apparatus in which a sunshine is effectively concentrated using a reflection surface of an inner vertical side of a transparent crystal for thereby maximizing the generation of power of a solar cell module, and in a nighttime, a light emission is maximized using a crystal, and the light emitted from a light emitting device is reflected by a reflection surface of a vertical side surface of the crystal, so that it is possible to more clearly display a display information such as a character or image etched on a crystal.

### Technical Solution

To achieve the above objects, there is provided a light emitting display device equipped with a transparent crystal which comprises an outer casing which is embedded under the ground and forms an outer structure; a transparent crystal member which is inserted into the interior of the outer casing and reflects light using a reflection mirror effect of an inner vertical wall surface of the same; a solar cell module which is impregnated into a space formed at a center lower surface of the transparent crystal member with the help of a molding liquid and concentrates a sunshine and converts a light energy into an electrical energy and changes the same; and a light emitting unit which is engaged at a lower surface of a surrounding portion of the transparent crystal member and emits light to the outside based on a power supply by means of the sunshine or the solar cell module.

### Advantageous Effects

In the present invention, a sunshine is effectively concentrated using a reflection surface of an inner vertical side of a transparent crystal, and a power generation of a solar cell module is maximized, and in a nighttime, the light emission is maximized using a crystal, and the light emitted from a light emitting device is reflected by a reflection surface of a vertical side surface of the crystal, so that it is possible to more clearly display a display information such as a character or image etched on a crystal.

### BRIEF DESCRIPTION OF THE DRAWINGS

FIG. 1 is a cross sectional view illustrating a road display device using a solar cell in the conventional art.

FIG. 2 is a perspective view illustrating a light emitting display device equipped with a transparent crystal according the present invention.

FIG. 3 is a disassembled perspective view of FIG. 2.

FIG. 4 is a cross sectional view of a use example of a light emitting display device equipped with a transparent crystal according to the present invention.

FIG. 5 is a view of a use of a light emitting display device equipped with a transparent crystal according to an embodiment of the present invention.

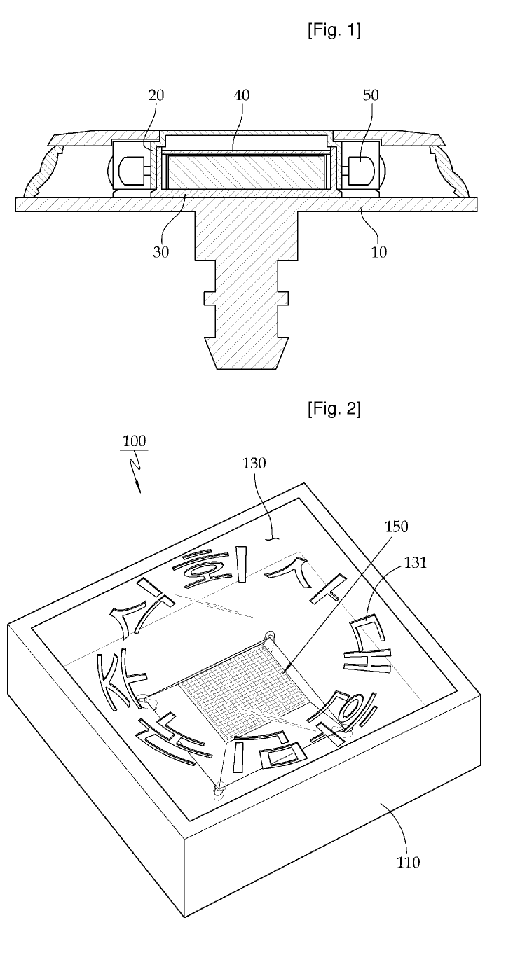

### BEST MODE FOR CARRYING OUT THE INVENTION

The light emitting display device equipped with a transparent crystal comprises an outer casing which is embedded under the ground and forms an outer structure; a transparent crystal member which is inserted into the interior of the outer casing and reflects light using a reflection mirror effect of an inner vertical wall surface of the same; a solar cell module which is impregnated into a space formed at a center lower surface of the transparent crystal member with the help of a molding liquid and concentrates a sunshine and converts a light energy into an electrical energy and changes the same; and a light emitting unit which is engaged at a lower surface of a surrounding portion of the transparent crystal member and emits light to the outside based on a power supply by means of the sunshine or the solar cell module.

A display information such as a character or an image is etched on the transparent crystal member.

There is further provided a safety member at an inner bottom surface of the outer casing for supporting the weight applied from the upper side of the same.

There is further provided a color seat member between the safety member and the reflection member.

The light emitting unit is formed of at least one light emitting device provided at a light guide plate and a side cross section surface of the light guide plate.

The light guide plate is embossed, and said light emitting device is impregnated into a lower outer side of the molding unit formed by a molding liquid.

### MODE FOR THE INVENTION

The embodiments of the present invention will be described with reference to the accompanying drawings.

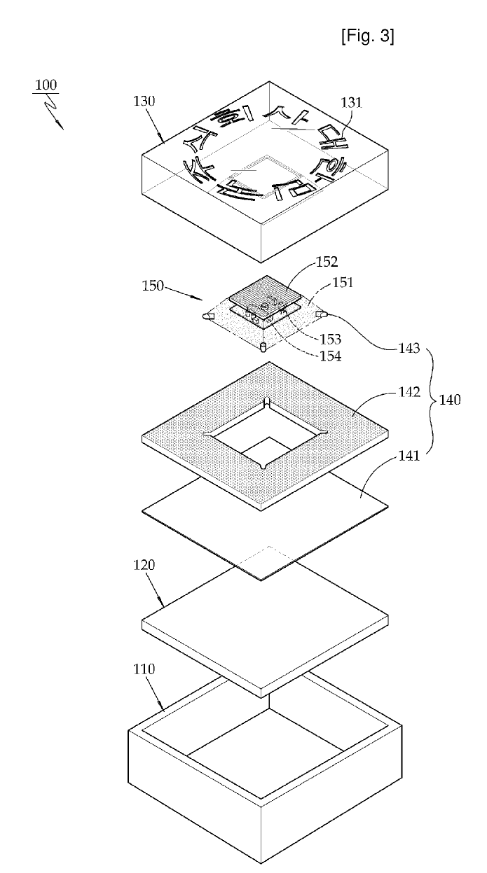

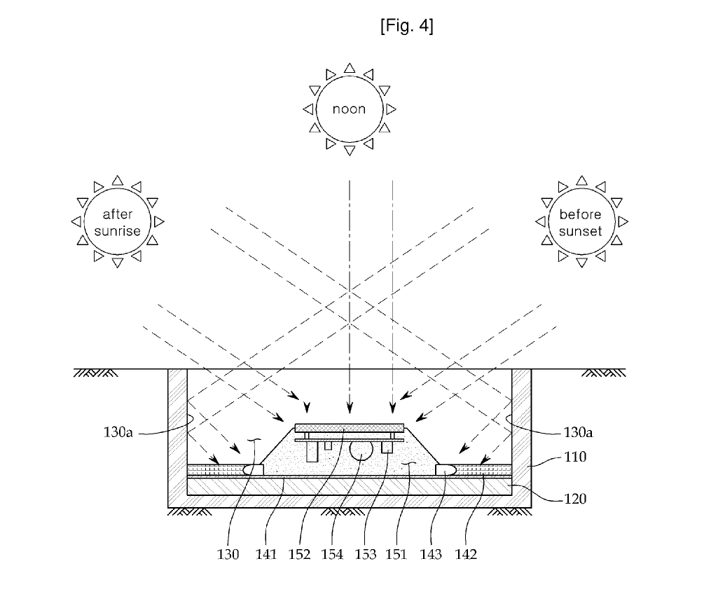

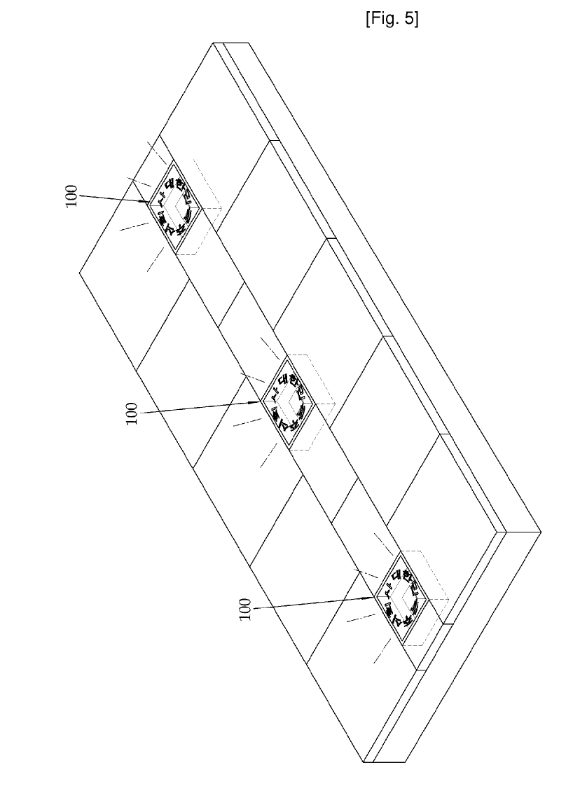

FIG. 2 is a perspective view illustrating a light emitting display device equipped with a transparent crystal according the present invention. FIG. 3 is a disassembled perspective view of FIG. 2. FIG. 4 is a cross sectional view of a use example of a light emitting display device equipped with a transparent crystal according to the present invention. FIG. 5 is a view of a use of a light emitting display device equipped with a transparent crystal according to an embodiment of the present invention.

The light emitting display device 100 equipped with a transparent crystal according to the present invention comprises an outer casing 110, a safety member 120, a transparent crystal member 130, a solar cell module 150, and a light emitting unit 140. In the following the elements will be described in the above sequence.

The outer casing will be described.

The outer casing is embedded under the ground and is a kind of a protecting casing for protecting the elements of the present invention with respect to a weight or pressure applied from the outside or the surrounding portion. It may protect the elements which may collide with a certain rock under the ground when the light emitting display device is installed. The outer casing 110 is made of a thick ABS casing or a cast (die casting) material.

The safety member will be described.

The safety member 120 is engaged at an inner bottom surface of the outer casing 110 for preventing the damages due to an external weight of the elements engaged at the upper side and is installed corresponding to the entire surface area of the transparent crystal member 130. The safety member 120 is preferably made of a steel plate which is able to endure the impacts by a weight of the upper elements and an external weight.

The transparent crystal member will be described.

The transparent crystal member 130 is engaged at an upper side of the safety member 120 and is designed to reflect light using a reflection mirror effect of the reflection surface 130a corresponding to an inner vertical wall surface of the crystal member 130. It is inserted into the interior of the outer casing 110 and is adhered using an epoxy resin for thereby making the engagement of the outer casing 110 and the transparent crystal member 130 more stable. The transparent crystal member 130 has a relatively high strength of about the Mohs hardness 7 and has a transparent mineral characteristic.

As shown in FIG. 3, the inner vertical side surface of the transparent crystal member 130 has a reflection mirror effect. When a sunshine incidence angle is less in the early morning or in the late afternoon time, the light is reflected by the opposite inner vertical reflection surface 130a of the crystal 130 positioned opponent to the same for thereby maximizing the concentration of the sunshine 200.

So, when the inclined sunshine 200 is received from the horizontal surface in the sunrise time or the sunset time, the inclined sunshine 200 is reflected by the inner vertical reflection surface 130a of the transparent crystal member 130, so that the brightness of the interior of the crystal 130 is maximized, whereby it is possible to allow the solar cell module 150 to output the power in maximum.

The solar cell module used for the display device, which uses a solar cell and light emitting diode in the conventional art, receives the sunshine 200 at 11 am through 2 pm and generates an electrical energy. However, in the present invention, a lot of the sunshine 200 is received at the time of 9 am to 5 pm with the help of the reflection mirror effect by the inner vertical reflection surface of the crystal member 130 of the present invention for thereby generating a lot of the electrical energy.

The solar cell module 150 used in the light emitting display device according to the present invention is able to charge electrical energy for more time period, so that it is possible to decrease the manufacturing cost by using a smaller device as compared to the conventional art.

A certain display information 131 such as a character or an image may be formed on the crystal member 130 if needed. The information is displayed along with the light emitted from the light emitting unit 140, so that it is possible to recognize the information. The display information 131 may be etched on the inner side of the crystal using a laser. The 3D display information 131 is displayed with the help of the light from the light emitting unit 140, so that it is recognized from the outside. The display information 131 can be more clearly displayed based on the light color from a high luminance light emitting device 143 of the light emitting unit 140. The character or image forming the display information 131 may be properly formed depending on the place in which the present invention is installed. As shown in FIG. 2, the character of Korean corporation may be displayed at the front side of the building in which the present invention is installed or the character of Entrance, Exit or Arrow indication may be displayed on a front side of the building or on the road.

The solar cell module will be described.

The solar cell module 150 comprises a solar cell 152 which is impregnated by a molding liquid such as a silicon or polycarbonate in the inner space formed at the center lower surface of the transparent crystal member 130 and concentrates the sunshine 200 and converts a light energy into an electrical energy, a charging circuit unit 153 for charging the electrical energy from the solar cell 152, and a battery unit 154 for storing the electrical energy.

Since the construction and operation of the solar cell module 150 is a known art, the descriptions of the same will be omitted.

The solar cell 152 is a device for concentrating the sunshine 200 and generating power. It is covered on the upper side in a transparent cover type so as to concentrate more luminance based on the light reflected in the interior of the crystal by means of the crystal member 130. The charge circuit unit 153 is an electronic circuit unit for amplifying the electrical energy from the solar cell 152 into an optimum electrical energy. The battery unit 154 stores the electrical energy from the solar cell 152 and is connected with the charging circuit unit 153 for thereby maximizing the storage of the amplified voltage current.

The operation that the solar cell module 150 is molded in the inner space of the crystal member 130 will be described.

First, the solar cell module 150 including the solar cell 152, the charging circuit unit 153 and the battery unit 154 is engaged at the center lower surface of the crystal member 130, and a silicon liquid or a polycarbonate is filled, and then the air is removed using a vacuum de-foaming machine (not shown), and it is dried at about 40˜60 and is slowly hardened for about one day for thereby forming the molding unit 151.

The light emitting unit will be described.

The light emitting unit 140 is engaged at a lower surface of the surrounding portions of the transparent crystal member 130 and emits light to the outside based on the power supply by the sunshine 200 or the solar cell module 150 and comprises a color seat member 141, an embossing light guide plate 142, and a light emitting device 143.

The color seat member 141 is engaged between the safety member 120 and the crystal member 130. When the sunshine 200 is emitted in the daytime, the color of the color seat member 141 is reflected by the reflection surface 130a of the vertical wall surface of the crystal member 130, and it is possible to a display information 131 such a character or image etched on the crystal member 130 along with the patterns of the embossing light guide plate 142. In the night time, the clearance of the light is enhanced based on the light emitting color of the light emitting device 143 for thereby enhancing a visibility.

The embossing light guide plate 142 is a semitransparent material member disposed on the upper side of the color seat member 141, and an embossed pattern is formed on the surface of the embossing light guide plate 142. The thickness of the embossing light guide plate 142 is preferably larger than the diameter of the light emitting device 143 by more than about 8 mm. The thickness is determined enough to endure the weight of the crystal member 130 disposed on the same and an external weight. One side surface of the embossing light guide plate 142 is concaved inwardly with the size of the light emitting device 143, and the other side surface of the same is adhered with a reflection tape such as an aluminum tape for thereby preventing the light from the light emitting device 143 from being leaked to the other side surface.

The light emitting device 143 is impregnated unto the lower outer side of the molding unit 151 formed by means of molding liquid for fixing the solar cell module 150 at a lower surface of the crystal member 130 and is inwardly embedded into the concave portion formed at a side surface of the embossing light guide plate 142. The light emitting device 143 emits light into the interior of the embossing light guide plate 142 in the night time by using the electrical energy charged by means of the solar light 200 in the daytime as a power supply source, and the light is spread to the upper side of the embossing light guide plate 142, so that the display information 131 formed on the crystal member 130 is displayed. Here, the displayed display information 131 is reflected by the reflection surface 130a of the inner vertical side surface of the crystal member 130, so that it can be more clearly displayed to the outside.

The light emitting device 143 is electrically connected with the solar cell module 150. Since the construction of the same is a known-art, the descriptions of the same will be omitted. The assembling process and operations of the light emitting display device equipped with a transparent crystal according to the present invention will be described.

The assembling process will be described first. A space is formed at the center lower surface of the crystal member 130, and the solar cell module 150 formed of the solar cell 152, the charging circuit unit 153 and the battery unit 154 and the light emitting device 143 are inputted into the space, and a molding liquid such as a silicon liquid or a polycarbonate liquid is filled, and the air is removed from the space using the vacuum de-foaming machine (not shown), and it is dried at about 40˜60 C, and is slowly hardened for about 1 day for thereby forming the molding unit 151.

The safety member 120 is placed on the bottom surface of the outer casing 110, and the embossing light guide plate 142 is placed on the safety member 120, and the molded light emitting device 143 is engaged at one side of the embossing light guide plate 142, and a reflection tape such as an aluminum tape is attached to the other side surface, and the crystal member 130 molded with the solar cell module 150 and the light emitting device 143 is engaged at the embossing light guide plate 142.

The operation of the present invention will be described. In the daytime, the light energy of the sunshine 200 is converted into an electrical energy by means of the solar cell module 150 and is charged, and in the nighttime, the charged electrical energy is supplied to the light emitting device 143, so that the light emitting device 143 emits light. The emitted light is incident into the embossing light guide plate 142, and the light is spread to the upper side of the embossing light guide plate 142, and the spread light is reflected by the vertical reflection surface 130a of the crystal member 130 or is incident into the upper side of the crystal member 130. The display information 131 formed on the surface of the crystal member 130 is more clearly displayed.

In the daytime, when the sunshine 200 emits, the color of the color seat member 141 is reflected by the reflection surface 130a of the vertical wall surface of the crystal member 130 along with the embossing pattern of the embossing light guide plate 142, and the light is incident into the upper surface of the crystal member 130. So, the display information 131 such as a character or an image etched on the crystal member 130 is displayed.

### INDUSTRIAL APPLICABILITY

In the present invention, a sunshine is effectively concentrated using a reflection surface of an inner vertical side of a transparent crystal, and a power generation of a solar cell module is maximized, and in a nighttime, the light emission is maximized using a crystal, and the light emitted from a light emitting device is reflected by a reflection surface of a vertical side surface of the crystal, so that it is possible to more clearly display a display information such as a character or image etched on a crystal.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

### SEQUENCE LISTING

LED, display information, solar cell module, image display

1. A light emitting display device equipped with a transparent crystal, comprising:
an outer casing which is embedded under the ground and forms an outer structure;
a transparent crystal member which is inserted into the interior of the outer casing and reflects light using a reflection mirror effect of an inner vertical wall surface of the same;
a solar cell module which is impregnated into a space formed at a center lower surface of the transparent crystal member with the help of a molding liquid and concentrates a sunshine and converts a light energy into an electrical energy and changes the same; and
a light emitting unit which is engaged at a lower surface of a surrounding portion of the transparent crystal member and emits light to the outside based on a power supply by means of the sunshine or the solar cell module.

2. The device of claim 1, wherein a display information such as a character or an image is etched on the transparent crystal member.

3. The device of either claim 1 or claim 2, further comprising a safety member at an inner bottom surface of the outer casing for supporting the weight applied from the upper side of the same.

4. The device of claim 3, further comprising a color seat member between the safety member and the reflection member.

5. The device of claim 1, wherein said light emitting unit is formed of at least one light emitting device provided at a light guide plate and a side cross section surface of the light guide plate.

6. The device of claim 5, wherein said light guide plate is embossed, and said light emitting device is impregnated into a lower outer side of the molding unit formed by a molding liquid.
